(19) United States
(12) Patent Application Publication
(10) Pub. No.: US 2026/0289357 A1
(43) Pub. Date: Sep. 24, 2026

(54) ENERGY EFFICIENCY FOR INFERENCING WORKLOADS

(71) Applicant: Intel Products IP LLC, Santa Clara, CA (US)

(72) Inventor: Christopher Michael MACNAMARA, Limerick (IE)

(21) Appl. No.: 19/685,383

(22) Filed: May 22, 2026

(51) Int. Cl. G06N 5/046; G06F 1/28

(52) U.S. Cl. CPC G06N 5/046; G06F 1/28

(57) ABSTRACT

Methods, software, and apparatus for energy efficiency for inferencing workloads. An inference large language model (LLM) is run on a multi-core processor on a compute platform via execution of instructions on a portion of processor cores while metrics relating to core utilization for running the inference LLM and one or more performance metrics are generated. The one or more performance metrics are compared with target performance metrics and the core utilization for running the inference LLM is adjusted to improve power utilization while meeting the target performance metrics. Adjusting core utilization comprises adjusting the number of cores and/or adjusting power states of cores that are utilized for running the inference LLM. Performance metrics may include one or more LLM metrics such as latency metrics. Software components include user space daemons and kernel space governors.

### BACKGROUND INFORMATION

The use of machine learning and artificial intelligence (AI) has expanded exponentially in recent years. Likewise, this has led to an exponential increase in computer resources and power usage. Cloud-hosted generative AI Large Language Models (LLMs) or suites of LLMs such as ChatGPT®, LLaMA®, Claude®, Gemini®, etc., enable users/subscribers to access LLMs through inferencing. LLM inference is the process of using a trained language model to generate outputs (text, code, or embeddings) from input prompts. During inference, the model processes the input through its transformer layers to predict the probability of possible next tokens. Then, the model generates the response using one or more tokens while using previously generated tokens as context. The process is highly compute and memory-intensive, requiring optimization techniques like quantization and caching to manage latency and costs.

### BRIEF DESCRIPTION OF THE DRAWINGS

The foregoing aspects and many of the attendant advantages of this disclosure will become more readily appreciated as the same becomes better understood by reference to the following detailed description, when taken in conjunction with the accompanying drawings, wherein like reference numerals refer to like parts throughout the various views unless otherwise specified:

FIG. 1 is a graph illustrating CPU utilization versus time for an exemplary LLM inference workflow;

FIG. 2 is a graph illustrating the relationship between the number of CPU cores and response latency for an exemplary generative AI model deployment;

FIG. 3 is a diagram comparing a conventional default behavior of LLaMA on the left and an improved power utilization LLaMA implementation on the right;

FIG. 4 is a system diagram illustrating some of the components used by embodiments herein;

FIG. 5 is a closed-loop control diagram illustrating operations performed by selected components to implement aspects of the embodiments here;

FIG. 6 is a diagram illustrating user space daemons on eBPF and associated governors, according to one embodiment;

FIGS. 7a and 7b are diagrams of respective embodiments of software architectures illustrating user space and kernel space components;

FIG. 8 is a graph illustrating latency verses number of cores for an exemplary LLM inferencing workload with a third axis of CPU power (consumed) in Watts; and

FIG. 9 is a diagram of a compute node or compute platform that may be implemented with aspects of the embodiments described and illustrated herein.

### DETAILED DESCRIPTION

Embodiments of methods, software, and apparatus for energy efficiency for inferencing workloads are described herein. In the following description, numerous specific details are set forth to provide a thorough understanding of embodiments disclosed herein. One skilled in the relevant art will recognize, however, that the embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the embodiments describe and illustrated herein, solutions are provided for reducing power consumption of inferencing workloads while maintaining performance metrics. The solutions improve LLMs at runtime by understanding their behavior and selectively activate cores/compute resources to run the workload efficiently. The embodiments may include a new controller to manage the core allocations of inferencing workloads while maintaining key performance metrics of the LLM.

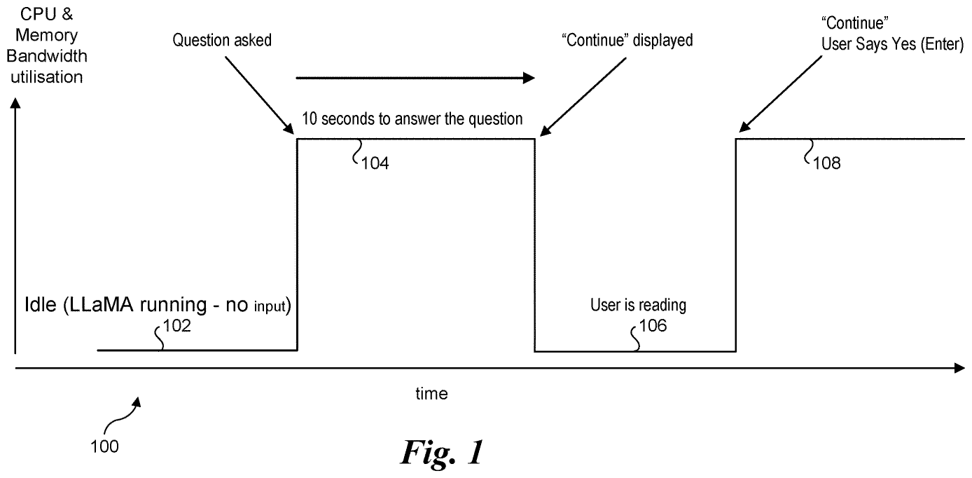

FIG. 1 shows a graph 100 illustrating CPU utilization versus time for an exemplary LLM inference workflow. When applied to an application, core utilization relates to how the core is utilized for the application, which is also referred to as the activity of usage of an application running on a given core. For context, the processes on the server(s) used to implement an LLM inference workflow are considered as the application here.

During an idle phase 102, the LLM (LLaMA in this example) is idle. Users interact with cloud-hosted AI services via Web service interfaces such as Web pages that enable users to enter text prompts and provide additional inputs such as uploading files and the like. While the user is entering a prompt, the prompt content can be buffered or cached by the Web browser or provided to a cloud-side front-end interface (e.g., a Web server or the like) as the prompt content is being entered. The user finishes the prompt via an action/control implemented by the Web page. In response to the user action, the prompt is provided as an input to LLaMA. This is depicted by “Question asked” in FIG. 1. In response, the CPU utilization goes from idle to a workload level under which the LLaMA performs LLM inference to answer the question during an inference phase 104. In this example, inference phase 104 lasts for 10 seconds. Upon completion, LLaMA will provide a response comprising an output answer, such as a text output that is used to update the Web page to display the answer to the user via the Web page. A control or selection such as “Continue” is displayed.

As the Web page is updated the user will read the text answer, as depicted by a user reading phase 106. During the reading phase, LLaMA's workload is returned to idle. In response to reading the answer the user will select the “Continue” action/control (e.g., by entering “Yes” and/or using the “Enter” key) in the Web page, which results in LLaMA returning to perform a next inference operation during an inference phase 108. This sequence continues in a similar manner until the user either chooses to not continue or stops providing prompts.

Under another common usage scenario, the user will enter a prompt, which will be processed by the LLaMA, which will return a result/output comprising a response that may be one or more paragraphs in length and consume one or more tokens, depending on how the model is structured. The user will review the response and provide another prompt, which will be processed by LLaMA, which will return another response. The sequence follows a user prompt-model response pattern, with LLaMA cycling between various idles states and inference workload states.

These prompt-response patterns may include one or more generation boundaries, which may be caused by:
Max token limit reached
Application-level chunking
UX (User Experience) pacing (to avoid long unbroken outputs)

A pause occurs while waiting for user input. During a pause or pause period the model may be idle, partially idle, or fully idle, depending on the implementation.

An LLM's latency is typically measured using the following metrics in TABLE 1 and benchmarks such as MLPerf LoadGen, NVIDIA GenAI-Perf, and vLLM internal metrics collect this data.

TABLE 1

| | |
|---|---|
| Time To First Token (TTFT) | Prompt → first token |
| Inter-Token Latency (ITL) | Time between tokens |
| End-to-End Latency | Prompt → final token |
| Tokens per Second (TPS) | Generation throughput |
| Requests per Second (RPS) | System-level concurrency |
| p50/p95/p99 latency | Tail latency |

p50/p95/p99 latency means 50 percentile, 95 percentile, and 99 percentile latency.

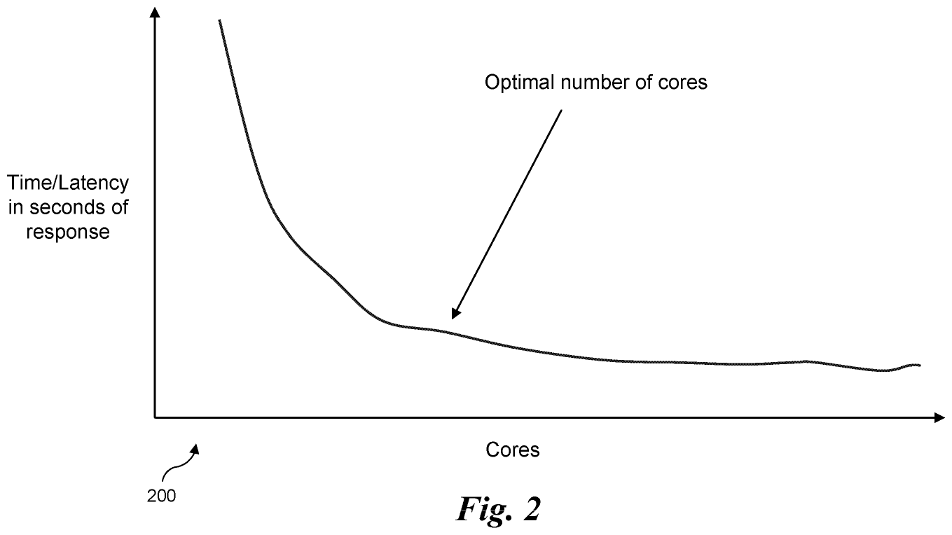

FIG. 2 shows a graph 200 illustrating the relationship between the number of CPU cores and response latency for an exemplary generative AI model deployment. As core count increases, latency improves up to an optimal point, after which gains level off. Influencing factors include CPU/core frequency, memory bandwidth, and model parameters.

As core count increases, a point is reached where the LLM cannot capitalize (e.g., performance metrics either cease to improve or the increase in performance is negligible. Finding the sweet spot of core count can be measured by benchmarking the latency or, as provided by embodiments herein, core count allocation and runtime power control. At runtime the LLM inferencing is typically using high memory bandwidth and memory capacity bound and not compute bound. Hence, an opportunity exists to improve core power utilization.

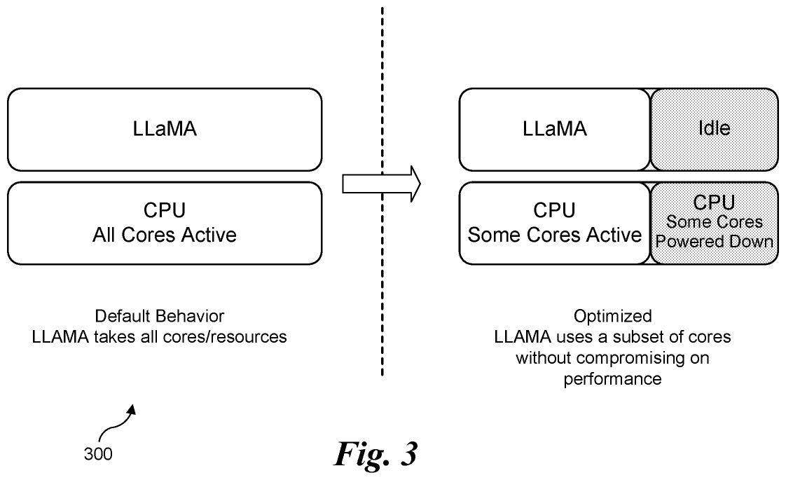

FIG. 3 shows a diagram 300 comparing a conventional default behavior of LLaMA on the left and an improved power utilization LLaMA implementation on the right. Under the conventional deployment, all CPU cores and associated resources (e.g., memory) remain active. In contrast, under the improved power utilization implementation, a subset of CPU cores are active and when in an idle state some of the subset of cores are powered down. Additionally, unused cores are powered down to save energy without impacting performance.

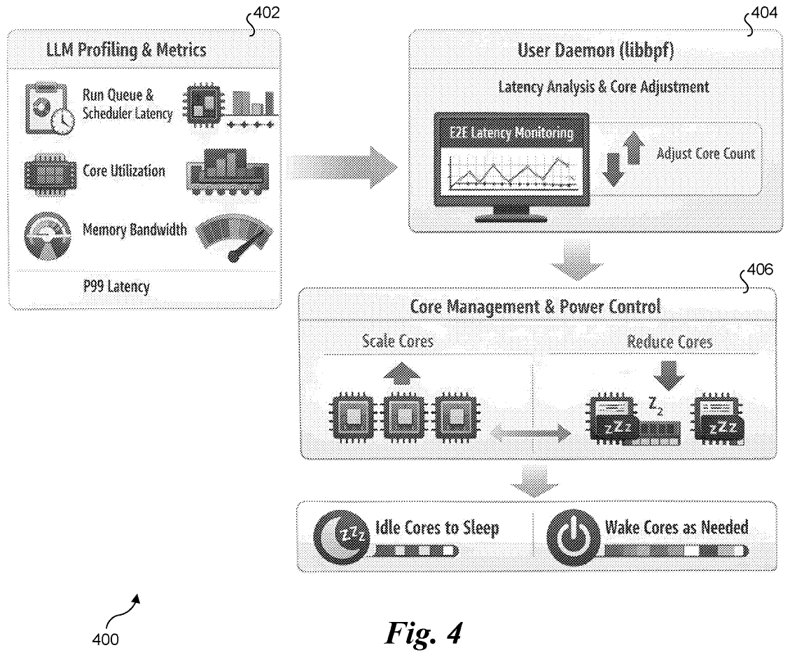

FIG. 4 shows a system diagram 400 illustrating some of the components used by embodiments of the solution. The components include LLM profiling and metrics 402, a user daemon 404, and core management & power control 406. The LLM profiling and metrics include run queue and scheduling latency, core utilization, and memory bandwidth profiling and metrics. The LLM profiling and metrics also may include one or more percentile latency metrics, such as P99 (99^{th} percentile) latency metrics.

In the illustrated embodiment, user daemon 404 is an libbpf component. In one aspect, some embodiments may use eBPF (Extended Berkeley Packet Filter) components and libraries that are available for Linux and Windows. libbpf is the reference library for eBPF development. libbpf has both user space components and eBPF components. The eBPF components are mostly pre-processor statements, forward declarations, and type definitions that make it easier to write eBPF programs. The user space components include a library used for loading eBPF programs and interacting with the loaded resources.

High-level features supported by libbpf include:
Provides high-level and low-level APIs for user space programs to interact with BPF programs. The low-level APIs wrap all the BPF system call functionality, which is useful when users need more fine-grained control over the interactions between user space and BPF programs.
Provides overall support for the BPF object skeleton generated by bpftool. The skeleton file simplifies the process for the user space programs to access global variables and work with BPF programs.
Provides BPF-side APIs, including BPF helper definitions, BPF maps support, and tracing helpers, allowing developers to simplify BPF code writing.
Supports BPF CO-RE mechanism, enabling BPF developers to write portable BPF programs that can be compiled once and run across different kernel versions.

One such libbpf component is user daemon 404, which is illustrative or one or more user daemon. The user daemon(s), which runs in user space, is/are used to perform latency analysis and core adjustment. Core adjustment includes adjusting the core count, that is adjusting the number of cores used by the LLM instance.

Core management & power control 406 resides in kernel space and is used to interface with platform hardware, which includes the processor cores, memory, and input-output (IO) interfaces. Exemplary operations include scaling the number of cores, reducing the number of cores, putting idle cores to sleep, and waking cores as needed. As detailed below, core management & power control 406 functionality is implemented using one or more governors.

Using eBPF, a governor can identify LLM idle periods via adding data to identify when the LLM is runnable. To benchmark the end to end (E2E) latency, the governor looks at the scheduler run queue and latency, the core utilization, the memory bandwidth and determines the LLMs “profile” and latency result. It also monitors the p99 latency. This is fed into the libbpf user daemon, which identifies the E2E latency and implements a method to increase or decrease the core count, as the core count is reduced the latency result is monitored to check for increases in latency. The governor also activates power sleep states on the cores no longer used and restores if needed.

In one implementation embodiment, eBPF metrics are collected, the user daemon is an eBPF program that consumes the metrics and decides on the power control via the E2E latency. The power control is effected by passing directions from the user daemon to one or more governors running in kernel space.

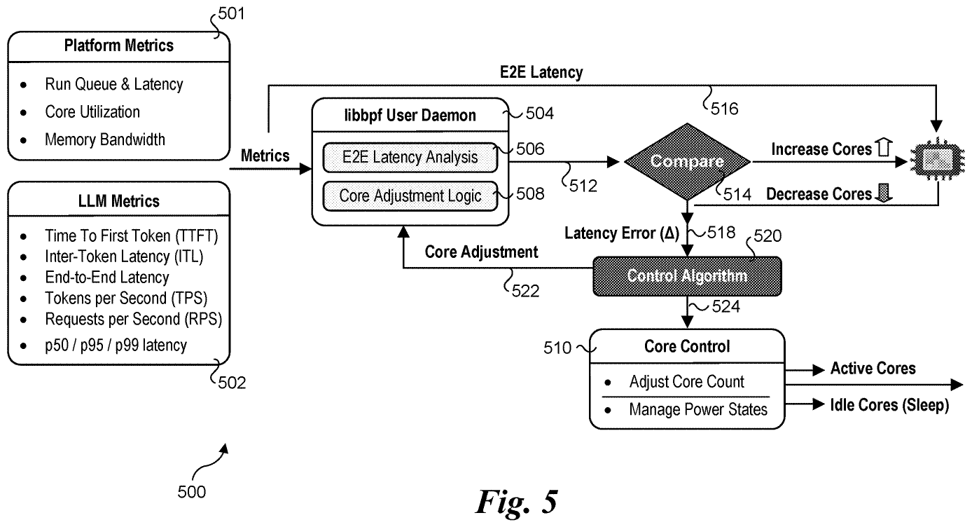

FIG. 5 shows a closed-loop control diagram 500 illustrating operations performed by selected components to implement the foregoing functionality, according to one embodiment. The components include platform metrics 501, LLM metrics 502, libbpf user daemon 504, which includes E2E latency analysis logic 506 and core adjustment logic 508, and core control block 510. Platform metrics 501 profiles and generates metrics including the aforementioned run queue and latency, core utilization, and memory bandwidth. LMM metrics 502 profiles and generates the metrics shown in TABLE 1 above including Time To First Token (TTFT), Inter Token Latency (ITL), End to End Latency, Tokens per Second (TPS), Requests per Second (RPS), and p50/p95/p99 latency. Platform metrics 501 and LLM metrics 502 are provided as inputs to libbpf user daemon 504, which performs E2E latency analysis. libbpf user daemon 504 provides an output comprising an E2E latency target. This E2E latency target is compared in a compare block 514 with E2E latency metrics 516 and based on this comparison the number of cores is increased or decreased. This difference between the target E2E latency and the E2E latency metrics results in a latency delta 518 that is provided as an input to a control algorithm 520.

Control algorithm 520 provides a core adjustment feedback 522 to libbpf user daemon 504 and a core control input 524 to core control block 510. Core control block 510 then adjusts the core count of active cores and manages power states of those cores, including selectively putting cores to sleep and waking cores up.

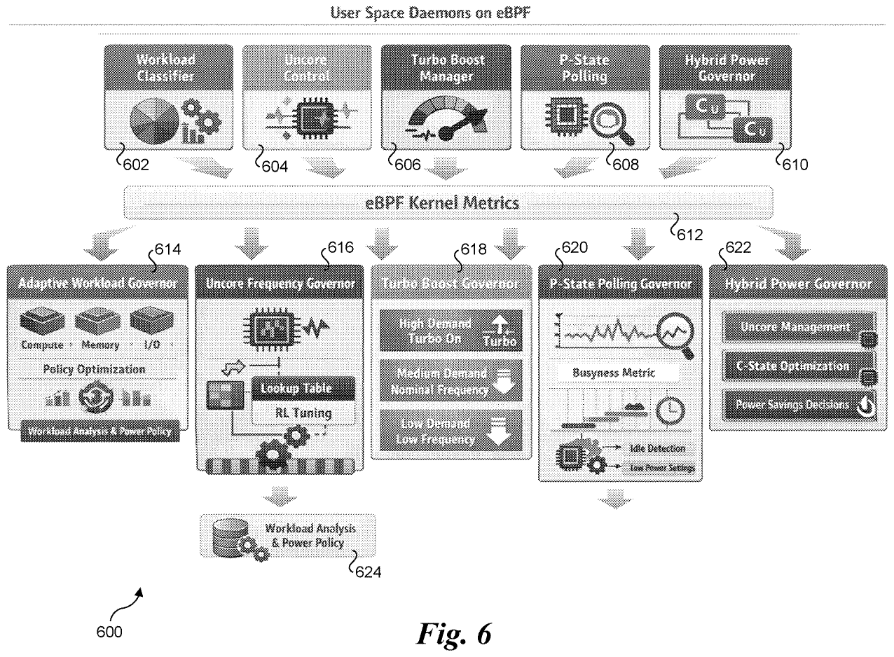

FIG. 6 shows a diagram 600 illustrating further details of user space daemons on eBPF and associated governors, according to one embodiment. The user space daemons on eBPF include a workload classifier 602, an uncore control block 604, a turbo boost manager 606, a P-State (power state) polling block 608, and a hybrid power governor user space daemon 610. The user space daemons on eBPF output eBPF kernel metrics 612 that are used for associated governors that reside in the kernel. The governors include an adaptive workload governor 614, an uncore frequency governor 616, a turbo boost governor 618, a P-state polling governor 620, and a hybrid power governor 622.

Adaptive workload governor 614 is used to govern adaptive workloads. It puts compute, memory, io bound metric collection, and workload classification metrics into groups and implements an algorithm that generates a power policy. This results in application specific adaption depending on workload types deployed to a node. Goals may differ for each workload type, e.g., IO bound require high uncore, compute bound required high frequencies and can reduce uncore freq=Perf/watt. TABLE 2 shows how different workload types affect core utilization, IO utilization, and memory bandwidth utilization.

TABLE 2

| | | | Mem B/W |
|---|---|---|---|
| Workload Type | Core Utilization | IO Utilization | Utilization |
| Compute Bound “A” | High (user app) | Low | Low |
| I/O Bound “B” | Low | High (waiting) | Varies |
| Memory Bound “C” | Varies | Varies | High |

Compute Bound workloads are not waiting on resources (IO-mem) and little time running kernel code, with high core utilization. IO bound workloads are waiting on resources (IO-mem), with low CPU utilization. Memory bound workloads are waiting on memory, cache misses are a feature, and sometimes have high core utilization.

Uncore frequency governor 616 is an AI-driven governor that is used to implement an uncore frequency controller based on utilization with thresholds for entering to max uncore frequency. The governor inputs are utilization per core, then a lookup table is used to determine if lowering uncore is the correct action. In one embodiment the lookup table is built with reinforcement learning (RL) and is user programmable (e.g., the user can provide RL tuning), enabling adjustment of compute uncore power settings. Uncore frequency governor 616 also outputs workload analysis and power policy 624 that is for the uncore components in the processor.

Turbo boost governor 618 is used to govern performance at different application demand points. At a programmed application utilization threshold, it may activate or deactivate turbo boost to address high performance application needs by increasing the frequency on a subset or all CPU cores. Below the threshold, the turbo governor will set a nominal frequency, and below another threshold a low frequency point. This will depend on the capacity of the application and the capacity of the core and the utilization.

P-state polling governor implements P-state polling of software threads that are running continuously but not exercising real work. In one embodiment, a “busyness” metric in the kernel is created and used by this governor. This governor may also be used for idle detection and low power settings.

Hybrid power governor 622 is a cross-technology (C/uncore) hybrid power governor combines the best of uncore and C states, resulting in lower power consumption. It uses an eBPF probe into the scheduler, C state residency, and uncore frequency and makes power saving decisions. Hybrid power governor 622 is also used to perform uncore management and C-State power adjustment.

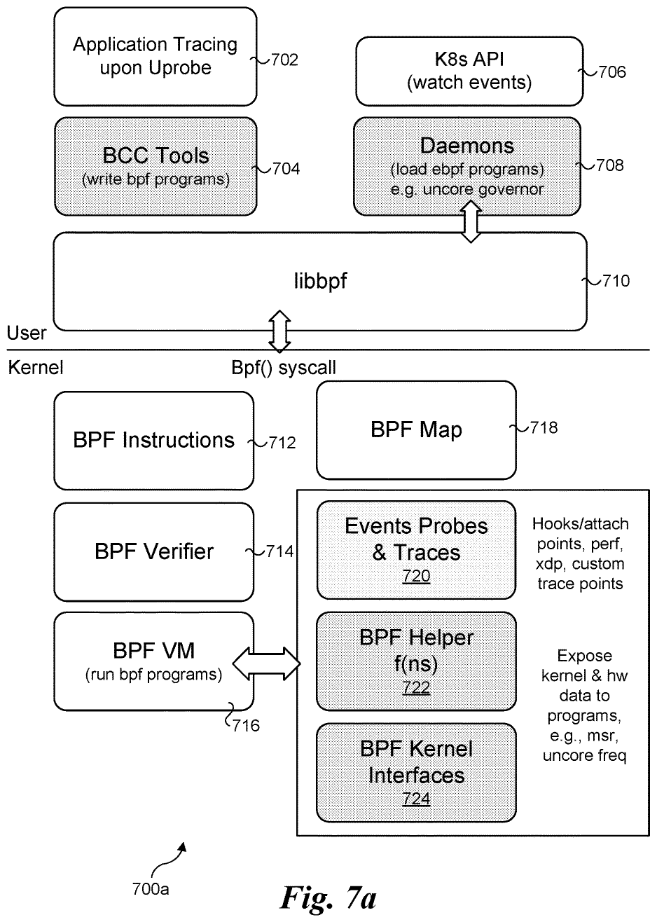

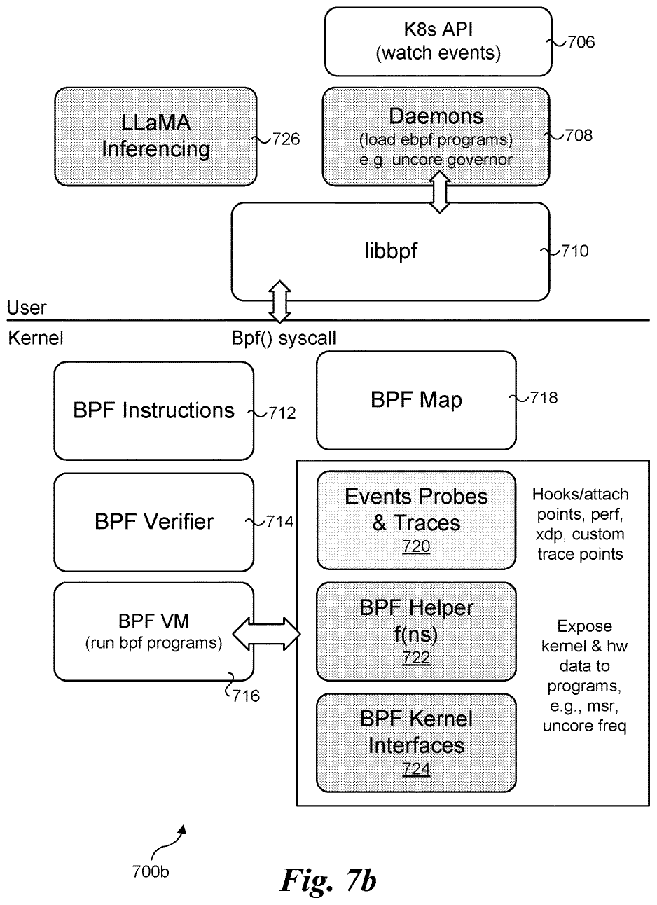

FIG. 7a shows a software architecture 700a that is used by some embodiments. The architecture is divided into user space and kernel space. In this diagram and the diagram for software architecture 700b of FIG. 7b, components shown with a white background are existing components while components shown with a gray background are new components.

The user space components include application tracing upon Uprobe 702, BCC tools 704 that are used to write bpf programs), K8s API (watch events) 706, daemons 708 and llbbpf 710. Existing kernel components include BPF instructions 712, a BPF verifier 714, a BPF virtual machine (VM) 716, and a BPF map 718. New kernel components include events probes and traces 720, BPF helper functions 722, and BPF kernel interfaces 724. Events probes and traces 720 comprise kernel hooks/attach points, perf, xdp (eXpress data path), and custom trace points. BPF helper functions 722 and BPF kernel interfaces 724 expose kernel and hardware data to program, such as MSR and uncore frequency.

As further shown in architecture diagram 700, llbbpf communicates with kernel components using Bpf( ) syscalls.

Like-numbered components in software architectures 700a of FIGS. 7a and 700b of FIG. 7b are the same or similar components under both software architectures. Software architectures 700b further includes LLaMA inferencing 726.

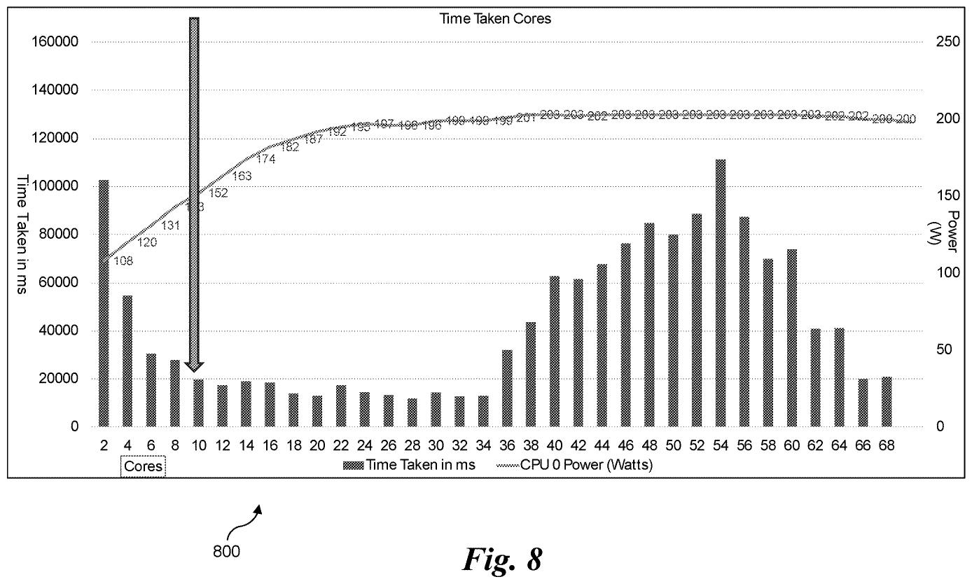

FIG. 8 shows a graph 800 illustrating latency (time taken in milliseconds) verses number of cores for an exemplary LLM inferencing workload. The third axis at the right of the graph is CPU power (consumed) in Watts. As illustrated, there is an active number of cores corresponding to an improved power utilization (aka sweet spot) between latency performance and power consumption. Under the principles and teachings provided by the embodiments disclosed above, such the number of active cores can be dynamically determined for different inference workloads using different LLMs. The embodiments can be used to determine the sweet spot of cores required for inferencing workloads based on (any) latency metric for LLMs and power optimizes or frees those cores deemed surplus all while meeting the service level agreement (SLA) for the LLM and providing a good or better user experience.

Using an implementation of the solution described herein, right-sizing core usage delivers up to ~29% power savings without impacting performance or user experience. Energy efficiency improvements reduce operational costs and carbon footprint. Initial results with the Llama 2 7B inferencing workload on Xeon CPUs show significant reductions in power, signaling strong potential for broader improvement.

### Example Platform/Compute Node

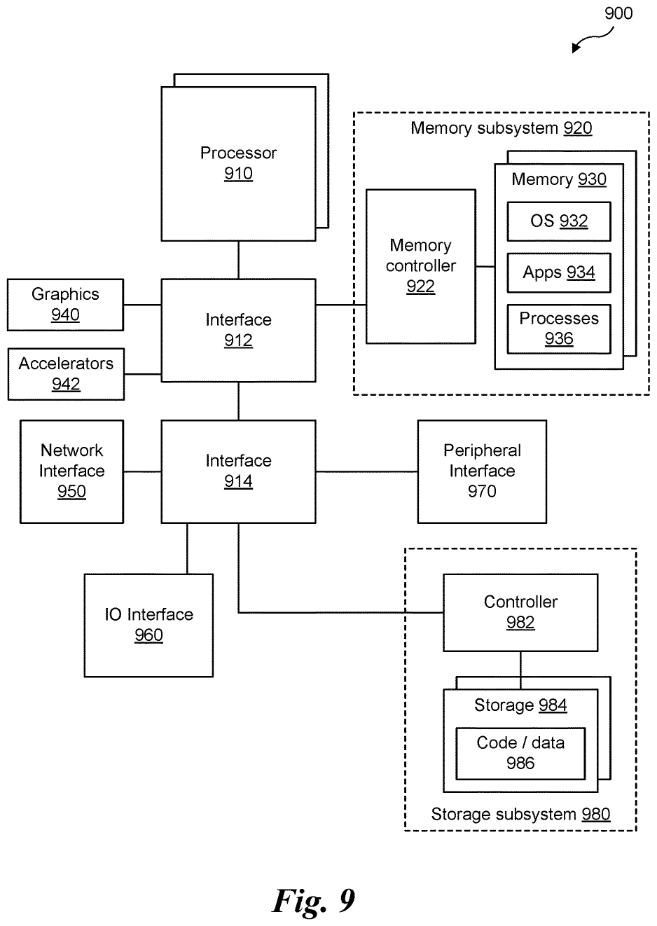

FIG. 9 depicts a compute node 900 in which aspects of the embodiments disclosed above may be implemented. Compute node 900, also referred to as a compute platform, includes one or more processors 910, which provides processing, operation management, and execution of instructions for compute node 900. Processor 910 can include any type of microprocessor, central processing unit (CPU), graphics processing unit (GPU), processing core, multi-core processor or other processing hardware to provide processing for compute node 900, or a combination of processors. For the embodiments herein, processor 910 is a multi-core processor comprising a System on a Chip (SoC) or System on Package (SoP). Processor 910 controls the overall operation of compute node 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, compute node 900 includes interface 912 coupled to processor 910, which can represent a higher speed interface or a high throughput interface for system components that needs higher bandwidth connections, such as memory subsystem 920 or optional graphics interface 940 components, or optional accelerators 942. Interface 912 represents an interface circuit, which can be a standalone component or integrated onto a processor die. Where present, graphics interface 940 interfaces to graphics components for providing a visual display to a user of compute node 900. In one example, graphics interface 940 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

In some embodiments, accelerators 942 can be a fixed function offload engine that can be accessed or used by a processor 910. For example, an accelerator among accelerators 942 can provide data compression capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 942 can provide multiple neural networks, CPUs, processor cores, general purpose graphics processing units, or graphics processing units can be made available for use by AI or ML models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 920 represents the main memory of compute node 900 and provides storage for code to be executed by processor 910, or data values to be used in executing a routine. Memory subsystem 920 can include memory 930 with one or more memory devices such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in compute node 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for compute node 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

While not specifically illustrated, it will be understood that compute node 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, compute node 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides compute node 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory. Network interface 950 can receive data from a remote device, which can include storing received data into memory. Various embodiments can be used in connection with network interface 950, processor 910, and memory subsystem 920.

In one example, compute node 900 includes one or more IO interface(s) 960. IO interface 960 can include one or more interface components through which a user interacts with compute node 900 (e.g., audio, alphanumeric, tactile/touch, or other interfacing). Peripheral interface 970 can include any hardware interface not specifically mentioned above. Peripherals refer generally to devices that connect dependently to compute node 900. A dependent connection is one where compute node 900 provides the software platform or hardware platform or both on which operation executes, and with which a user interacts.

In one example, compute node 900 includes storage subsystem 980 to store data in a nonvolatile manner. In one example, in certain system implementations, at least certain components of storage system 980 can overlap with components of memory subsystem 920. Storage subsystem 980 includes storage 984 including one or more storage devices, which can be or include any conventional medium for storing large amounts of data in a nonvolatile manner, such as one or more magnetic, solid state, or optical based disks, or a combination. Storage 984 holds code or instructions and data 986 in a persistent state (i.e., the value is retained despite interruption of power to compute node 900). Storage 984 can be generically considered to be a “memory,” although memory 930 is typically the executing or operating memory to provide instructions to processor 910. Whereas storage 984 is nonvolatile, memory 930 can include volatile memory (i.e., the value or state of the data is indeterminate if power is interrupted to compute node 900). In one example, storage subsystem 980 includes controller 982 to interface with storage 984. In one example controller 982 is a physical part of interface 914 or processor 910 or can include circuits or logic in both processor 910 and interface 914.

Volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3) JESD79-3F, originally published by JEDEC (Joint Electronic Device Engineering Council) in June 2007. DDR4 (DDR version 4), JESD209-4D, originally published in September 2012, DDR5 (DDR version 5), JESD79-5B, originally published in June 2021, DDR6 (DDR version 6), currently in discussion by JEDEC, LPDDR3 (Low Power DDR version 3, JESD209-3C, originally published in August 2015, LPDDR4 (LPDDR version 4, JESD209-4D, originally published in June 2021), LPDDR5 (LPDDR version 5, JESD209-5B, originally published in June 2021), WIO2 (Wide Input/Output version 2), JESD229-2, originally published in August 2014, HBM (High Bandwidth Memory, JESD235B, originally published in December 2018, HBM2 (HBM version 2, JESD235D, originally published in March 2021, HBM3 (HBM version 3, JESD238A originally published in January 2023) or HBM4 (HBM version 4), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of compute node 900. More specifically, power source typically interfaces to one or multiple power supplies in compute node 900 to provide power to the components of compute node 900. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, compute node 900 can be implemented using interconnected compute sleds of processors, memories, storages, network interfaces, and other components. In some implementations, a disaggregated architecture under which compute, memory, and storage and pooled in respective interconnect sleds or chassis in racks. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (ROCE), Peripheral Component Interconnect express (PCIe), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

The following examples pertain to additional examples of the teachings and principles disclosed herein.

Example 1. A method for implementing an inferencing workload on a compute platform including a processor with a plurality of cores, comprising running an inference large language model (LLM) on the compute platform via execution of instructions on a portion of the plurality of cores, generating metrics relating to core utilization for running the inference LLM and one or more performance metrics, comparing the one or more performance metrics with one or more target performance metrics, and adjusting the core utilization for running the inference LLM to meet the one or more performance metrics.

Example 2. The method of example 1, wherein adjusting core utilization comprises adjusting a number of cores that are utilized for running the inference LLM.

Example 3. The method of example 1 or 2, wherein adjusting core utilization comprises adjusting a power state of one or more cores that are utilized for running the inference LLM.

Example 4. The method of any of the preceding examples, wherein the one or more performance metrics and the one or more target performance metrics includes at least one LLM metric.

Example 5 The method of example 4, wherein the at least one LLM metric includes two or more of: Time To First Token; Inter Token Latency; End-to-End Latency; Tokens per Second; Requests per Second; and a percentile latency.

Example 6. The method of any of the preceding examples, wherein the method employs one or more governors to adjust the core utilization for running the inference LLM to meet the one or more performance metrics.

Example 7. The method of example 6, wherein the one or more governors comprise eBPF (Extended Berkeley Packet Filter) programs.

Example 8. The method of example 6, wherein the method employs one or more user space daemons running in user space that provide metrics to the one or more governors running in kernel space.

Example 9. The method of example 8, wherein the one or more user space daemons comprise eBPF (Extended Berkeley Packet Filter) components.

Example 10. A non-transitory machine-readable medium have first instructions stored thereon configured to be execution on a multi-core processor of a compute platform having a plurality of processor cores, wherein execution of the first instructions enable the compute platform to generate metrics relating to core utilization and one or more performance metrics while running an inference large language model (LLM) on the compute platform via execution of second instructions on a portion of the plurality of cores, compare the one or more performance metrics with one or more target performance metrics, and adjust the core utilization for running the inference LLM to meet the one or more performance metrics.

Example 11. The non-transitory machine-readable medium of example 10, wherein adjusting core utilization comprises adjusting a number of cores that are utilized for running the inference LLM.

Example 12. The non-transitory machine-readable medium of example 10 or 11, wherein adjusting core utilization comprises adjusting a power state of one or more cores that are utilized for running the inference LLM.

Example 13. The non-transitory machine-readable medium of any of examples 10-12, wherein the first instructions include instructions for one or more governors that, when executed, enable the compute platform to adjust the core utilization for running the inference LLM to meet the one or more performance metrics.

Example 14. The non-transitory machine-readable medium of example 12, wherein the one or more governors are configured to be run in kernel space and wherein the first instructions include instructions for one or more user space daemons configured to run in user space and, when executed, provide metrics to the one or more governors.

Example 15. The non-transitory machine-readable medium of example 13, wherein the one or more governors comprise eBPF (Extended Berkeley Packet Filter) components.

Example 16. A compute platform, comprising a processor having a plurality of cores, memory, operatively coupled to the processor and instructions, loaded in the memory or stored in a storage device operatively coupled to the processor. The instructions are configured to be executed on processor cores among the plurality of processor cores to enable the compute platform to run an inference large language model (LLM) on the compute platform via execution of a portion of the instructions on a portion of the plurality of cores, generate metrics relating to core utilization for running the inference LLM and one or more performance metrics, compare the one or more performance metrics with one or more target performance metrics, and adjust the core utilization for running the inference LLM to meet the one or more performance metrics.

Example 17. The compute platform of example 16, wherein adjusting core utilization comprises adjusting a number of cores that are utilized for running the inference LLM, wherein unused cores are powered down to save energy while maintaining the one or more target performance metrics.

Example 18. The compute platform of example 16 or 17 wherein the instructions include instructions for one or more governors that, when executed, enable the compute platform to adjust the core utilization for running the inference LLM to meet the one or more performance metrics.

Example 19. The compute platform of example 18, wherein the one or more governors are configured to be run in kernel space in the memory and wherein the instructions further include instructions for one or more user space daemons configured to run in user space in memory and, when executed, provide metrics to the one or more governors.

Example 20. The compute platform of example 19, wherein the one or more user space daemons and the one or more governors comprise eBPF (Extended Berkeley Packet Filter) components.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

As discussed above, various aspects of the embodiments herein may be facilitated by corresponding software and/or firmware components and applications, such as software and/or firmware executed by an embedded processor or the like. Thus, embodiments may be used as or to support a software program, software modules, firmware, and/or distributed software executed upon some form of processor, processing core, or embedded logic, or a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments, including what is described in the Abstract, is not intended to be exhaustive or to limit the embodiments to the precise forms disclosed. While specific embodiments of, and examples for, the teachings and principles are described herein for illustrative purposes, various equivalent modifications are possible within the scope of the claims, as those skilled in the relevant art will recognize.

These modifications can be made to the embodiments in light of the above detailed description. The terms used in the following claims should not be construed to limit the claim scope to the specific embodiments disclosed in the specification and the drawings. Rather, the scope of the claims is to be determined entirely by the following claims, which are to be construed in accordance with established doctrines of claim interpretation.

What is claimed is:

1. A method for implementing an inferencing workload on a compute platform including a processor with a plurality of cores, comprising:
running an inference large language model (LLM) on the compute platform via execution of instructions on a portion of the plurality of cores;
generating metrics relating to core utilization for running the inference LLM and one or more performance metrics;
comparing the one or more performance metrics with one or more target performance metrics; and
adjusting the core utilization for running the inference LLM to meet the one or more performance metrics.

2. The method of claim 1, wherein adjusting core utilization comprises adjusting a number of cores that are utilized for running the inference LLM.

3. The method of claim 1, wherein adjusting core utilization comprises adjusting a power state of one or more cores that are utilized for running the inference LLM.

4. The method of claim 1, wherein the one or more performance metrics and the one or more target performance metrics includes at least one LLM metric.

5. The method of claim 4, wherein the at least one LLM metric includes two or more of:
Time To First Token;
Inter Token Latency;
End-to-End Latency;
Tokens per Second;
Requests per Second; and
a percentile latency.

6. The method of claim 1, wherein the method employs one or more governors to adjust the core utilization for running the inference LLM to meet the one or more performance metrics.

7. The method of claim 6, wherein the one or more governors comprise eBPF (Extended Berkeley Packet Filter) programs.

8. The method of claim 6, wherein the method employs one or more user space daemons running in user space that provide metrics to the one or more governors running in kernel space.

9. The method of claim 8, wherein the one or more user space daemons comprise eBPF (Extended Berkeley Packet Filter) components.

10. A non-transitory machine-readable medium have first instructions stored thereon configured to be execution on a multi-core processor of a compute platform having a plurality of processor cores, wherein execution of the first instructions enable the compute platform to:
generate metrics relating to core utilization and one or more performance metrics while running an inference large language model (LLM) on the compute platform via execution of second instructions on a portion of the plurality of cores;
compare the one or more performance metrics with one or more target performance metrics; and
adjust the core utilization for running the inference LLM to meet the one or more performance metrics.

11. The non-transitory machine-readable medium of claim 10, wherein adjusting core utilization comprises adjusting a number of cores that are utilized for running the inference LLM.

12. The non-transitory machine-readable medium of claim 10, wherein adjusting core utilization comprises adjusting a power state of one or more cores that are utilized for running the inference LLM.

13. The non-transitory machine-readable medium of claim 10, wherein the first instructions include instructions for one or more governors that, when executed, enable the compute platform to adjust the core utilization for running the inference LLM to meet the one or more performance metrics.

14. The non-transitory machine-readable medium of claim 12, wherein the one or more governors are configured to be run in kernel space and wherein the first instructions include instructions for one or more user space daemons configured to run in user space and, when executed, provide metrics to the one or more governors.

15. The non-transitory machine-readable medium of claim 13, wherein the one or more governors comprise eBPF (Extended Berkeley Packet Filter) components.

16. A compute platform, comprising:
a processor having a plurality of cores;
memory, operatively coupled to the processor;
instructions, loaded in the memory or stored in a storage device operatively coupled to the processor and configured to be executed on processor cores among the plurality of processor cores to enable the compute platform to:
run an inference large language model (LLM) on the compute platform via execution of a portion of the instructions on a portion of the plurality of cores;
generate metrics relating to core utilization for running the inference LLM and one or more performance metrics;
compare the one or more performance metrics with one or more target performance metrics; and
adjust the core utilization for running the inference LLM to meet the one or more performance metrics.

17. The compute platform of claim 16, wherein adjusting core utilization comprises adjusting a number of cores that are utilized for running the inference LLM, wherein unused cores are powered down to save energy while maintaining the one or more target performance metrics.

18. The compute platform of claim 16 wherein the instructions include instructions for one or more governors that, when executed, enable the compute platform to adjust the core utilization for running the inference LLM to meet the one or more performance metrics.

19. The compute platform of claim 18, wherein the one or more governors are configured to be run in kernel space in the memory and wherein the instructions further include instructions for one or more user space daemons configured to run in user space in memory and, when executed, provide metrics to the one or more governors.

20. The compute platform of claim 19, wherein the one or more user space daemons and the one or more governors comprise eBPF (Extended Berkeley Packet Filter) components.
